(19) United States
(12) Patent Application Publication
(10) Pub. No.: US 2001/0000962 A1
(43) Pub. Date: May 10, 2001

(54) Terminal for composing and presenting MPEG-4 video programs

(76) Inventor: Ganesh Rajan, Saratoga, CA (US)

Correspondence Address: LAW OFFICE OF BARRY R LIPSITZ, 755 MAIN STREET, MONROE, CT, 06468, US

(21) Appl. No.: 09/735,147

(22) Filed: Dec. 12, 2000

Related U.S. Application Data
(63) Continuation of application No. PCT/US99/14306, filed on Jun. 24, 1999.
(60) Provisional application No. 60/090,845, filed on Jun. 26, 1998.

(51) Int. Cl. G06F 9/46; G06F 15/16; H04N 7/173; G06F 13/00

(52) U.S. Cl. 345/302; 345/328; 709/102; 709/329; 709/219; 725/86

(57) ABSTRACT

A method and apparatus for composing and presenting multimedia programs using the MPEG-4 standard at a multimedia terminal (100). A composition engine (120) maintains and updates a scene graph (124) of the current objects, including their relative position in a scene and their characteristics, and provides a corresponding list of objects (126) to be displayed to a presentation engine (150). In response, the presentation engine begins to retrieve the corresponding decoded object data that is stored in respective composition buffers (176, . . . 186). The presentation engine assembles the decoded objects to provide a scene for presentation on output devices such as a video monitor (240) and speakers (242), or for storage. A terminal manager (110) receives user commands and causes the composition engine to update the scene graph and list of objects accordingly. The terminal manager also forwards the information contained in the object descriptors to a scene decoder (122) at the composition engine. Preferably, the composition and the presentation of the content are controlled using separate control threads to allow the presentation engine to retrieve and process the decoded object data while the composition engine is recovering additional scene description information and/or object descriptors.

1. This application claims the benefit of U.S. Provisional Application No. 60/090,845, filed Jun. 26, 1998.

### BACKGROUND OF THE INVENTION

2. The present invention relates to a method and apparatus for composing and presenting multimedia video programs using the MPEG-4 (Motion Picture Experts Group) standard. More particularly, the present invention provides an architecture wherein the composition of a multimedia scene and its presentation are processed by two different entities, namely a “composition engine” and a “presentation engine.”

3. The MPEG-4 communications standard is described, e.g., in ISO/IEC 14496-1 (1999): “Information Technology—Very Low Bit Rate Audio-Visual Coding—Part 1” Systems; ISO/IEC JTC1/SC29/WG11, MPEG-4 Video Verification Model Version 7.0 (February 1997); and ISO/IEC JTC1/SC29/WG11 N2725, MPEG-4 Overview (March 1999/Seoul, South Korea).

4. The MPEG-4 communication standard allows a user to interact with video and audio objects within a scene, whether they are from conventional sources, such as moving video, or from synthetic (computer generated) sources. The user can modify scenes by deleting, adding or repositioning objects, or changing the characteristics of the objects, such as size, color, and shape, for example.

5. The term “multimedia object” is used to encompass audio and/or video objects.

6. The objects can exist independently, or be joined with other objects in a scene in a grouping known as a “composition”. Visual objects in a scene are given a position in two- or three-dimensional space, while audio objects can be placed in a sound space.

7. MPEG-4 uses a syntax structure known as Binary Format for Scenes (BIFS) to describe and dynamically change a scene. The necessary composition information forms the scene description, which is coded and transmitted together with the media objects. BIFS is based on VRML (the Virtual Reality Modeling Language). Moreover, to facilitate the development of authoring, manipulation and interaction tools, scene descriptions are coded independently from streams related to primitive media objects.

8. BIFS commands can add or delete objects from a scene, for example, or change the visual or acoustic properties of objects. BIFS commands also define, update, and position the objects. For example, a visual property such as the color or size of an object can be changed, or the object can be animated.

9. The objects are placed in elementary streams (ESs) for transmission, e.g., from a headend to a decoder population in a broadband communication network, such as a cable or satellite television network, or from a server to a client PC in a point-to-point Internet communication session. Each object is carried in one or more associated ESs. A scaleable object may have two ESs for example, while a non-scaleable object has one ES. Data that describes a scene, including the BIFS data, is carried in its own ES.

10. Furthermore, MPEG-4 defines the structure for an object descriptor (OD) that informs the receiving system which ESs are associated with which objects in the received scene. ODs contain elementary stream descriptors (ESDs) to inform the system which decoders are needed to decode a stream. ODs are carried in their own ESs and can be added or deleted dynamically as a scene changes.

11. A synchronization layer, at the sending terminal, fragments the individual ESs into packets, and adds timing information to the payload of these packets. The packets are then passed to the transport layer and subsequently to the network layer, for communication to one or more receiving terminals.

12. At the receiving terminal, the synchronization layer parses the received packets, assembles the individual ESs required by the scene, and makes them available to one or more of the appropriate decoders.

13. The decoder obtains timing information from an encoder clock, and time stamps of the incoming streams, including decode time stamps and composition time stamps.

14. MPEG-4 does not define a specific transport mechanism, and it is expected that the MPEG-2 transport stream, asynchronous transfer mode, or the Internet's Real-time Transfer Protocol (RTP) are appropriate choices.

15. The MPEG-4 tool “FlexMux” avoids the need for a separate channel for each data stream. Another tool (Digital Media Interface Format—DMIF) provides a common interface for connecting to varying sources, including broadcast channels, interactive sessions, and local storage media, based on quality of services (QoS) factors.

16. Moreover, MPEG-4 allows arbitrary visual shapes to be described using either binary shape encoding, which is suitable for low bit rate environments, or gray scale encoding, which is suitable for higher quality content.

17. However, MPEG-4 does not specify how shapes and audio objects are to be extracted and prepared for display or play, respectively.

18. Accordingly, it would be desirable to provide a general architecture for a decoding system that is capable of receiving and presenting programs conforming to the MPEG-4 standard.

19. The terminal should be capable of composing and presenting MPEG-4 programs.

20. The composition of a multimedia scene and its presentation should be separated into two entities, i.e., a composition engine and a presentation engine.

21. The scene composition data, received in the BIFS format, should be decoded and translated into a scene graph in the composition engine.

22. The system should incorporate updates to a scene, received via the BIFS stream or via local interaction, into the scene graph in the composition engine.

23. The composition engine should make available a list of multimedia objects (including displayable and/or audible objects) to the presentation engine for presentation, sufficiently prior to each presentation instant.

24. The presentation engine should read the objects to be presented from the list, retrieve the objects from content decoders, and render the objects into appropriate buffers (e.g., display and audio buffers).

25. The composition and presentation of content should preferably be performed independently so that the presentation engine does not have to wait for the composition engine to finish its tasks before the presentation engine accesses the presentable objects.

26. The terminal should be suitable for use with both broadband communication networks, such as cable and satellite television networks, as well as computer networks, such as the Internet.

27. The terminal should also be responsive to user inputs.

28. The system should be independent of the underlying transport, network and link protocols.

29. The present invention provides a system having the above and other advantages.

### SUMMARY OF THE INVENTION

30. The present invention relates to a method and apparatus for composing and presenting multimedia video programs using the MPEG-4 standard.

31. A multimedia terminal includes a terminal manager, a composition engine, content decoders, and a presentation engine. The composition engine maintains and updates a scene graph of the current objects, including their relative position in a scene and their characteristics, to provide a list of objects to be displayed or played to the presentation engine. The list of objects is used by the presentation engine to retrieve the decoded object data that is stored in respective composition buffers of content decoders.

32. The presentation engine assembles the decoded objects according to the list to provide a scene for presentation, e.g., display and playing on a display device and audio device, respectively, or storage on a storage medium.

33. The terminal manager receives user commands and causes the composition engine to update the scene graph and list of objects in response thereto.

34. Moreover, the composition and the presentation of the content are preferably performed independently (i.e., with separate control threads).

35. Advantageously, the separate control threads allow the presentation engine to begin retrieving the corresponding decoded multimedia objects while the composition engine recovers additional scene description information from the bitstream and/or processes additional object descriptor information provided to it.

36. A composition engine and a presentation engine should have the ability to communicate with each other via interfaces that facilitate the passing of messages and other data between themselves.

37. A terminal for receiving and processing a multimedia data bitstream, and a corresponding method are disclosed.

### BRIEF DESCRIPTION OF THE DRAWINGS

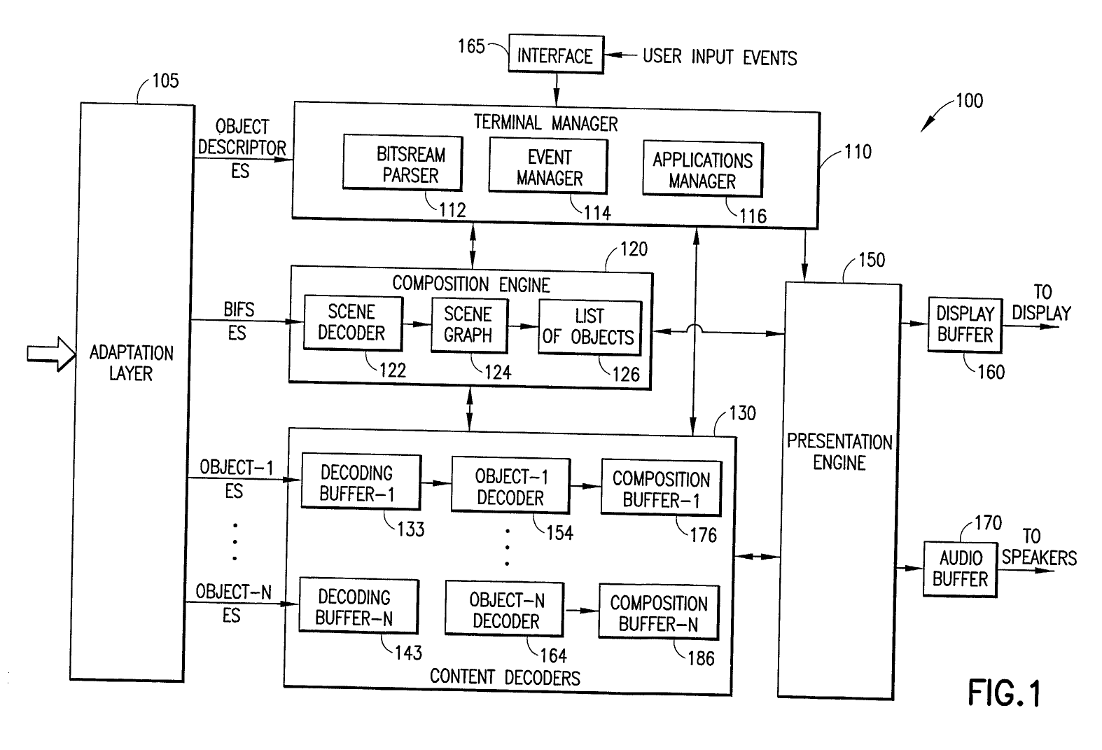

38. FIG. 1 illustrates a general architecture for a multimedia receiver terminal capable of receiving and presenting programs conforming to the MPEG-4 standard in accordance with the present invention.

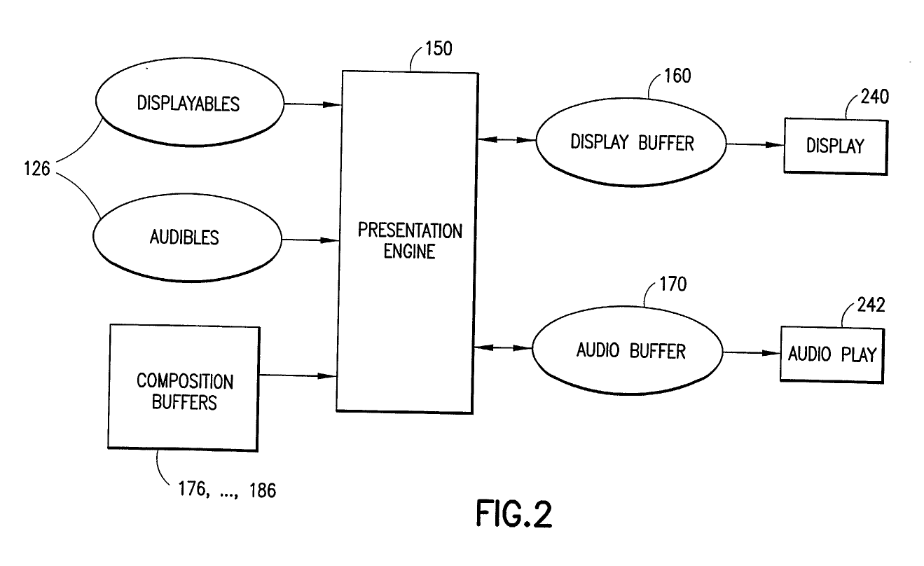

39. FIG. 2 illustrates the presentation process in the terminal architecture of FIG. 1 in accordance with the present invention.

### DETAILED DESCRIPTION OF THE INVENTION

40. The present invention relates to a method and apparatus for composing and presenting multimedia video programs using the MPEG-4 standard.

41. FIG. 1 illustrates a general architecture for a multimedia receiver terminal capable of receiving and presenting programs conforming to the MPEG-4 standard in accordance with the present invention.

42. According to the MPEG-4 Systems standard, the scene description information is coded into a binary format known as BIFS (Binary Format for Scene). This BIFS data is packetized and multiplexed at a transmission site, such as a cable and or satellite television headend, or a server in a computer network, before being sent over a communication channel to a terminal 100. The data may be sent to a single terminal or to a terminal population. Moreover, the data may be sent via an open-access network or via a subscriber network.

43. The scene description information describes the logical structure of a scene, and indicates how objects are grouped together. Specifically, an MPEG-4 scene follows a hierarchical structure, which can be represented as a directed acyclic (tree) graph, where each node or a group of nodes, of the graph, represents a media object. The tree structure is not necessarily static, since node attributes (e.g., positioning parameters) can be changed while nodes can be added, replaced, or removed.

44. The scene description information can also indicate how objects are positioned in space and time. In the MPEG-4 model, objects have both spatial and temporal characteristics. Each object has a local coordinate system in which the object has a fixed spatial-temporal location and scale. Objects are positioned in a scene by specifying a coordinate transformation from the object's local coordinate system into a global coordinate system defined by one more parent scene description nodes in the tree.

45. The scene description information can also indicate attribute value selection. Individual media objects and scene description nodes expose a set of parameters to a composition layer through which part of their behavior can be controlled. Examples include the pitch of a sound, the color for a synthetic object, activation or deactivation of enhancement information for scaleable coding, and so forth.

46. The scene description information can also indicate other transforms on media objects. The scene description structure and node semantics are heavily influenced by VRML, including its event model. This provides MPEG-4 with an extensive set of scene construction operators, including graphics primitives that can be used to construct sophisticated scenes.

47. The “TransMux” (Transport Multiplexing) layer of MPEG-4 models the layer that offers transport services matching the requested QoS. Only the interface to this layer is specified by MPEG-4. The concrete mapping of the data packets and control signaling may be performed using any desired transport protocol. Any suitable existing transport protocol stack, such as Real-time Transfer Protocol (RTP)/User Datagram Protocol (UDP)/Internet protocol (IP), ATM Adaptation Layer (AAL5)/Asynchronous Transfer Mode (ATM), or MPEG-2's Transport Stream over a suitable link layer may become a specific TransMux instance. The choice is left to the end user/service provider, and allows MPEG-4 to be used in a wide variety of operational environments.

48. In the present example, it is assumed for illustration only, that an ATM adaptation Layer 105 is used for transport.

49. The multiplexed packetized streams are received at an input of the multimedia terminal 100. The various descriptors, starting with the ObjectDescriptor, are parsed from an object descriptor ES, e.g., at a parser 112. The elementary stream descriptor (ESDescriptor), contained within the first object descriptor (called the Initial ObjectDescriptor), contains a pointer locating the Scene Description stream (BIFS stream) from among the incoming multiplexed streams. In a broadcast scenario, the BIFS stream is located from among the incoming multiplexed streams. For Internet-type scenarios, wherein there is a guaranteed back channel connection from the MPEG-4 terminal to the underlying network, the BIFS stream may be retrieved from a remote server. The information about the various elementary streams are contained in the ObjectDescriptors and its associated descriptors. For details, see ISO/IEC CD 14496-1: Information Technology—Very low bit rate audio-visual coding Part 1: Systems (Committee Draft of MPEG-4 Systems), incorporated herein by reference.

50. The parser 112, which is a general bitstream parser for the parsing of the various descriptors, is incorporated within a terminal manager 110.

51. The BIFS bitstream containing the scene description information is received at the BIFS Scene Decoder 122, which is shown as a component of a Composition Engine 120. The coded elementary content streams (comprising video, audio, graphics, text, etc.) are routed to their respective decoders according to the information contained in the received descriptors. The decoders for the elementary content or object streams have been grouped within a box 130 labeled “Content Decoders”.

52. For example, an object-l elementary stream (ES) is routed to an input decoding buffer-1 122, while an object-N ES is routed to a decoding buffer-N 132. The respective objects are decoded, e.g., at object-1 decoder 124, . . . , object-N decoder 134, and provided to respective output, composition buffers, e.g., composition buffer-l 126, . . . , composition buffer-N 136. The decoding may be scheduled based on Decode Time Stamp (DTS) information.

53. Note that it is possible for the data from two or more decoding buffers to be associated with one decoder, e.g., for scaleable objects.

54. The composition engine 120 performs a variety of functions. Specifically, when a received elementary stream is a BIFS stream, the composition engine 120 creates and/or updates a scene graph at a scene graph function 124 using the output of the BIFS scene decoder 122. The scene graph provides complete information on the composition of a scene, including the types of objects present and the relative position of the objects. For example, a scene graph may indicate that a scene includes one or more persons and a synthetic, computer-generated 2-D background, and the positions of the persons in the scene.

55. When a received elementary stream is a BIFSAnimation stream, the appropriate spatial-temporal attributes of the components of the scene graph are updated at the scene graph function 124. Thus, the composition engine 120 maintains the status of the scene graph and its components.

56. From the scene graph function 124, the composition engine 120 creates a list of video objects 126 to be displayed by a presentation engine 150, and a list of audible objects to be played by the Presentation Engine 150. For generality, both video and audio objects are referred to herein as being “displayed” or “presented” on an appropriate output device. For example, video objects can be presented on a video screen, such as a television screen or computer monitor, while audio objects can be presented via speakers. Of course, the objects can also be stored on a recording device, such as a computer's hard drive, or a digital video disc, without a user actually viewing or listening to them. The presentation engine thus provides the objects in a state in which they can be presented to some final output device, either for immediate viewing/listening and/or storage for subsequent use.

57. Moreover, the term “list” will be used herein to indicate any type of listing regardless of the specific implementation. For example, the list may be provided as a single list for all objects, or separate lists may be provided for different object types (e.g., video or audio), or more than one list may be provided for each object type. The list of objects is a simplified version of the scene graph information. It is only important for the presentation engine 150 to be able to use the list to recognize the objects and route them to appropriate underlying rendering engines.

58. The multimedia scene that is presented can include a single, still video frame or a sequence of video frames.

59. The composition engine 120 manages the list, and is typically the only entity that is allowed to explicitly modify the entries in the list.

60. Some of the presentable objects may be available in the composition buffers 126, . . . , 136 in a decoded format. If so, this is indicated in the description of the objects in the list of objects 126.

61. The composition engine 120 makes the list available to the presentation engine 150 in a timely manner so that the presentation engine 150 can present the scene at the desired time instants, according to the desired presentation rate specified for the program. The presentation engine 150 presents a scene by retrieving the decoded objects from the buffers 126, . . . , 136 and providing the decoded video objects to a display buffer 160, and by providing the decoded audio objects to an audio buffer 170. The objects are subsequently presented on a display device and speakers, respectively, and/or stored at a recording device. The presentation engine 150 retrieves the decoded objects at preset presentation rates using known time stamp techniques, such as Composition Time Stamps (CTSs).

62. The composition engine 120 also provides the scene graph information from the scene graph function 124 to the presentation engine 150. However, the provision of the simplified list of objects allows the presentation engine to begin retrieving the decoded objects.

63. The composition engine 120 thus manages the scene graph. It updates the attributes of the objects in the scene graph based on factors that include a user interaction or specification, a pre-specified spatio-temporal behavior of the objects in the scene graph, which is a part of the scene graph itself; and commands received on the BIFS stream, such as BIFS updates or BIFSAnimation commands.

64. The composition engine 120 is also responsible for the management of the decoding buffers 122, . . . , 132 and the composition buffers 126, . . . , 136 allocated for this particular application by the terminal 100. For example, the composition engine 120 ensures that these buffers do not overflow or underflow. The composition engine 120 can also implement buffer control strategies, e.g., in accordance with the MPEG-4 conformance specifications.

65. The terminal manager 110 includes an event manager 114, an applications manager 116 and a clock 118.

66. Multimedia applications may reside on the terminal manager 110 as designated by an applications manager 116. For example, these applications may be include user-friendly software run on a PC that allows a user to manipulate the objects in a scene.

67. The terminal manager 110 manages communications with the external world through appropriate interfaces. For example, an event manager 114, such as an example interface 165 which is responsive to user input events, is responsible for monitoring user interfaces, and detecting the related events. User input events include, e.g., mouse movements and clicks, keypad clicks, joystick movements, or signals from other input devices.

68. The terminal manager 110 passes the user input events to the composition engine 120 for appropriate handling. For example, a user may enter commands to re-position or change the attributes of certain objects within the scene graph.

69. User interface events may not be processed in some cases, e.g., for a purely broadcast program with no interactive content.

70. The terminal functions of FIG. 1 can be implemented using any known hardware, firmware and/or software. Moreover, the various functional blocks shown need not be independent but can share common hardware, firmware and/or software. For example, the parser 112 can be provided outside the terminal manager 110, e.g., in the composition engine 120.

71. Note that the content decoders 130 and composition engine 120 run independently of each other in the sense that their separate control threads (e.g., control cycles or loops) do not affect each other. Advantageously, by separating the composition and presentation threads, the presentation engine does not have to wait for the composition engine to finish its tasks (e.g., such as recovering additional scene description information or processing object descriptors) before the presentation engine accesses (e.g., begins to retrieve) the presentable objects from the buffers 126, . . . , 136. Thus, the presentation engine 150 runs in its own thread and presents the objects at its desired presentation rate, regardless of whether the composition engine 120 has finished its tasks or not.

72. The elementary stream decoders 124, . . . , 134 also run in their individual control threads independent of the presentation and composition engines. Synchronization between the decoding and the composition can be achieved using conventional time stamp data, such as DTS, CTS and PTS data as they are known from the MPEG-2 and MPEG-4 standards.

73. FIG. 2 illustrates the presentation process in the terminal architecture of FIG. 1 in accordance with the present invention.

74. From the list of objects 126, the presentation engine 150 obtains a list of displayables (e.g., video objects) and audibles (e.g., audio objects). The list of displayables and audibles is created and maintained by the composition engine 120, as discussed.

75. The presentation engine 150 also renders the objects to be presented into the appropriate frame buffers. The displayable objects are rendered into the display buffer 160, while the audible objects are rendered into the audio buffer 170. For this purpose, the presentation engine 150 interacts with the lower level rendering libraries disclosed in the MPEG-4 standard.

76. The presentation engine 150 converts the content in the composition buffers 126, . . . , 136 into the appropriate format before being rendered into the display or audio buffers 160, 170 for presentation on a display 240 and audio player 242, respectively.

77. The presentation engine 150 is also responsible for efficient rendering of presentable content including rendering optimization, scalability of the rendered data, and so forth.

78. Accordingly, it can be seen that the present invention provides a method and apparatus for composing and presenting multimedia programs using the MPEG-4 standard. A multimedia terminal includes a terminal manager, a composition engine, content decoders, and a presentation engine. The composition engine maintains and updates a scene graph of the current objects, including their positions in a scene and their characteristics, to provide a list of objects to be displayed to the presentation engine. The presentation engine retrieves the corresponding objects from content decoder buffers according to time stamp information.

79. The presentation engine assembles the decoded objects according to the list to provide a scene for display on display devices, such as a video monitor and speakers, and/or for storage on a storage device.

80. The terminal manager receives user commands and causes the composition engine to update the scene graph and list of objects in response thereto. The terminal manager also forwards object descriptors to a scene decoder at the composition engine.

81. Moreover, the composition engine and the presentation engine preferably run on separate control threads. Appropriate interface definitions can be provided to allow the composition engine and the presentation engine to communicate with each other. Such interfaces, which can be developed using techniques known to those skilled in the art, should allow the passing of messages and data between the presentation engine and the composition engine.

82. Although the invention has been described in connection with various specific embodiments, those skilled in the art will appreciate that numerous adaptations and modifications may be made thereto without departing from the spirit and scope of the invention as set forth in the claims.

83. For example, while various syntax elements have been discussed herein, note that they are examples only, and any syntax may be used.

84. Moreover, while the invention has been discussed in connection with the MPEG-4 standard, it should be appreciated that the concepts disclosed herein can be adapted for use with any similar communication standards, including derivations of the current MPEG-4 standard.

85. Furthermore, the invention is suitable for use with virtually any type of network, including cable or satellite television broadband communication networks, local area networks (LANs), metropolitan area networks (MANs), wide area networks (WANs), internets, intranets, and the Internet, or combinations thereof.

What is claimed is:

1. A terminal for receiving and processing a multimedia data bitstream, comprising:
a terminal manager;
a composition engine;
a plurality of content decoders; and
a presentation engine; wherein:
said content decoders recover and decode multimedia objects from respective elementary streams of the bitstream;
said multimedia objects comprising at least one of video objects and audio objects for presentation in a multimedia scene;
said composition engine recovers scene description information from the bitstream that defines specific ones of the recovered multimedia objects that are to be provided in the multimedia scene, and characteristics of the recovered multimedia objects in the multimedia scene;
said terminal manager recovers object descriptor information from the bitstream that associates said recovered multimedia objects with respective ones of said elementary streams, and provides the recovered object descriptor information to said composition engine;
said composition engine is responsive to said recovered object descriptor information provided thereto and said recovered scene description information for creating a list of said specific ones of the recovered multimedia objects that are to be displayed in said multimedia scene; and
said presentation engine obtains said list from said composition engine, and, in response thereto, retrieves the corresponding decoded multimedia objects from said content decoders to provide data corresponding to the multimedia scene to an output device.

2. The terminal of claim 1, wherein:
said composition engine and said presentation engine have separate control threads.

3. The terminal of claim 2, wherein:
said separate control threads allow the presentation engine to begin retrieving the corresponding decoded multimedia objects while the composition engine recovers additional scene description information from the bitstream and/or processes additional object descriptor information provided thereto.

4. The terminal of claim 1, wherein:
said content decoders, presentation engine and composition engine have separate control threads.

5. The terminal of claim 1, wherein:
said characteristics of the recovered multimedia objects in the multimedia scene include positions of said specific ones of the recovered multimedia objects in said multimedia scene.

6. The terminal of claim 1, wherein:
said recovered scene description information is provided according to a Binary Format for Scenes (BIFS) language

7. The terminal of claim 1, wherein:
said multimedia data bitstream is provided according to an MPEG-4 standard.

8. The terminal of claim 1, wherein:
said composition engine maintains scene graph information of a composition of said multimedia scene in response to said recovered object descriptor information provided thereto and said recovered scene description information for use in creating said list.

9. The terminal of claim 8, wherein:
said composition engine updates the scene graph information, and said list, as required, for successive multimedia scenes in response to subsequent recovered scene description information from the bitstream.

10. The terminal of claim 8, wherein:
said terminal manager is responsive to user input events at a user interface for providing corresponding data to said composition engine for modifying said scene graph, and said list, as required.

11. The terminal of claim 1, wherein:
said composition engine provides said list to said presentation engine according to a specified presentation rate.

12. The terminal of claim 1, wherein said multimedia objects comprise video and audio objects for presentation in the multimedia scene, further comprising:
video and audio buffers for buffering the video and audio objects, respectively, prior to presentation;
wherein said presentation engine reads objects from said list and provides them to the appropriate one of said video and audio buffers.

13. A terminal for receiving and processing a multimedia data bitstream, comprising:
decoding means for recovering and decoding multimedia objects from respective elementary streams of the bitstream;
said multimedia objects comprising at least one of video objects and audio objects for presentation in a multimedia scene;
composing means for recovering scene description information from the bitstream that defines specific ones of the recovered multimedia objects that are to be provided in the multimedia scene, and characteristics of the recovered multimedia objects in the multimedia scene;
managing means for recovering object descriptor information from the bitstream that associates said recovered multimedia objects with respective ones of said elementary streams, and providing the recovered object descriptor information to said composing means;
said composing means being responsive to said recovered object descriptor information provided thereto and said recovered scene description information for creating a list of said specific ones of the recovered multimedia objects that are to be displayed in said multimedia scene; and
presenting means for obtaining said list from said composing means, and, in response thereto, retrieving the corresponding decoded multimedia objects from said decoding means to provide data corresponding to the multimedia scene to an output device.

14. A method for receiving and processing a multimedia data bitstream at a terminal, comprising the steps of:
recovering and decoding multimedia objects from respective elementary streams of the bitstream at respective content decoders;
said multimedia objects comprising at least one of video and audio objects for presentation in a multimedia scene;
recovering scene description information from the bitstream that defines specific ones of the recovered multimedia objects that are to be provided in the multimedia scene, and characteristics of the recovered multimedia objects in the multimedia scene;
recovering object descriptor information from the bitstream that associates said recovered multimedia objects with respective ones of said elementary streams;
creating a list of said specific ones of the recovered multimedia objects that are to be displayed in said multimedia scene in response to said recovered object descriptor information and said recovered scene description information; and
retrieving the corresponding decoded multimedia objects in response to the list to provide data corresponding to the multimedia scene to an output device.

15. The method of claim 14, wherein:
said recovering steps are performed using control threads that are separate from said retrieving step.

16. The method claim 15, wherein:
said separate control threads allow the retrieving of the decoded multimedia objects to begin while the recovering of additional scene description information and/or the recovering of additional object descriptor information occurs.

17. The method of claim 14, wherein:
said creating step is performed using a control thread that is separate from said retrieving step.

18. The method of claim 14, wherein:
said recovering steps and said creating step are performed using control threads that are separate from said retrieving step.
